(19) United States
(12) Patent Application Publication
(10) Pub. No.: US 2009/0217246 A1
(43) Pub. Date: Aug. 27, 2009

(54) Evaluating Software Programming Skills

(75) Inventors: Shankar Kondur, Highland Park, NJ (US); Pawan Goyal, Bangalore (IN)

Correspondence Address: Ashok Tankha, 36 Greenleigh Drive, Sewell, NJ, 08080, US

(73) Assignee: NCE Technologies, Inc.

(21) Appl. No.: 12/037,955

(22) Filed: Feb. 27, 2008

(51) Int. Cl. G06F 9/44

(52) U.S. Cl. 717/126

(57) ABSTRACT

Disclosed herein is a method and system for evaluating the software programming skills of a candidate. A plurality of question compendia comprising a problem description, a set of evaluation test cases, and a skeleton code, is rendered based on the logical and technical levels of the candidate. The solution code created by the candidate is then transferred to a server for compilation and execution. The solution code is evaluated by examining the solution code for solution accuracy to the constructed problem, analyzing the solution code for code compliance with predefined coding conventions and standards, ascertaining memory utilization of the solution code and examining the exception handling capabilities of the solution code. The candidate is then provided with a consolidated ranking generated from scores allotted to the candidate during the evaluation of the solution code.

### CROSS REFERENCE TO RELATED APPLICATIONS

The following patent is incorporated herein as a reference:

1. Patent application titled “Method and System for Compilation and Execution of Software codes”, bearing the application number 1866/CHE/2007, and filed on Aug. 20, 2007 at the Indian Patent Office.

### BACKGROUND

This invention relates to evaluating the software programming skills of a candidate. More particularly, the invention relates to assessment of the software programming skills of a candidate by automatically evaluating a solution program code created by the candidate for a predefined problem.

In existing online or offline computer based testing methods, rendering of questions are usually not adaptive. The questions are sequentially selected from a pool of questions, without usually basing the selections on the real time performance of a candidate in such computer based tests. There is a need for intelligently rendering questions to the candidate based on the candidate's performance. Moreover, there is a need for rendering questions as a group of questions based on the logical and technical levels of the candidate to be evaluated.

In a typical testing scenario, multiple candidates attend the test simultaneously. In order to test the programming skills of such candidates, processing and evaluating the submitted source codes require efficient compilation and execution of the codes. In the existing methods of compiling a program code, a compiler parses the program code, links the parsed code with common libraries and system libraries, and creates an executable binary output of the program code. Employing the existing methods of compiling in the previously mentioned testing scenario may not be efficient. The source codes from multiple candidates are compiled separately with the earlier described steps of parsing, linking, and creating binary output. The overheads for compilation and execution of the source codes increases with the increase in the number of source codes.

Loading and parsing of common libraries and system libraries for every compilation process increases the compilation time. Further, handling multiple requests for compilation, as in the case of multiple candidate test scenario, may not be efficient. Therefore, a standard compiler may not achieve a large number of compilations simultaneously with limited resources. The above mentioned limitations increase with an increase in the number of candidates. Furthermore, effective analysis of programming skills requires evaluating candidates based on logical and technical complexities of the questions. Therefore, there is a need for task based assessment of the programming skills of the candidate.

In view of the foregoing discussion, there is an unmet need for a method and system to assess the software programming skills of a candidate by automatically evaluating a solution program code created by the candidate for a predefined problem.

### SUMMARY OF THE INVENTION

The method and system disclosed herein addresses the unmet need for assessing the software programming skills of a candidate by automatically evaluating a solution program code created by the candidate for a predefined problem. The method and system disclosed herein handle multiple requests for compilation simultaneously, and compiles and executes multiple codes with limited resources.

The method and system disclosed herein provides a plurality of question compendia to the candidate. The question compendia comprising a problem description, a set of evaluation test cases and a skeleton code is rendered to the candidate. Each of the question compendia is assigned a difficulty level based on logical and technical complexities of the constructed problem. The question compendia may be rendered to the candidate based on logical and technical levels of the candidate to be evaluated. With the help of the provided skeleton code, the candidate creates a source code as a solution code to the constructed problem in the question compendia.

The solution code created by the candidate is then transferred to a server for compilation. A compiler compiles the solution code created by the candidate upon initiation of a compilation request. The compiler loads and saves the common libraries and systems libraries required to compile each solution code in the memory. The storage of parsed common libraries and system libraries in the memory reduces the compilation time when the compiler is handling multiple compilation requests. The compiler loads and parses the solution code. The loaded solution code is linked to the parsed common libraries and system libraries stored in the memory. A binary format of the solution code is generated by the compiler. The binary format of the solution code serves as the executable of the solution code.

The solution code is then evaluated to assess the software programming skills of the candidate. During the evaluation of the solution code, the solution code is examined for solution accuracy to the constructed problem. The solution code is then analyzed for code compliance with predefined coding conventions and standards. The deviations of the parsed solution code from the predefined coding conventions and standards are recorded. Memory utilization and exception handling capabilities of the solution code are also examined during the evaluation of the code.

The solution code is further evaluated by executing the set of evaluation test cases on the solution code. The solution code may also be checked for invalid inputs. A test score is allotted to the candidate for obtaining a desired output of the solution code for each of the evaluation test cases. The allotted scores for each of the evaluation test cases is accumulated to rate the correctness of the solution code. Further, scores are allotted to the candidate based on the number of times the candidate compiles the solution code, memory optimization capabilities of the solution code, exception and error handling capabilities of the solution code, etc. A consolidated ranking is then calculated based on the cumulative scores allotted to the candidate.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of evaluating the software programming skills of a candidate.

FIG. 2 illustrates a system for evaluating the software programming skills of a candidate.

### DETAILED DESCRIPTION OF THE INVENTION

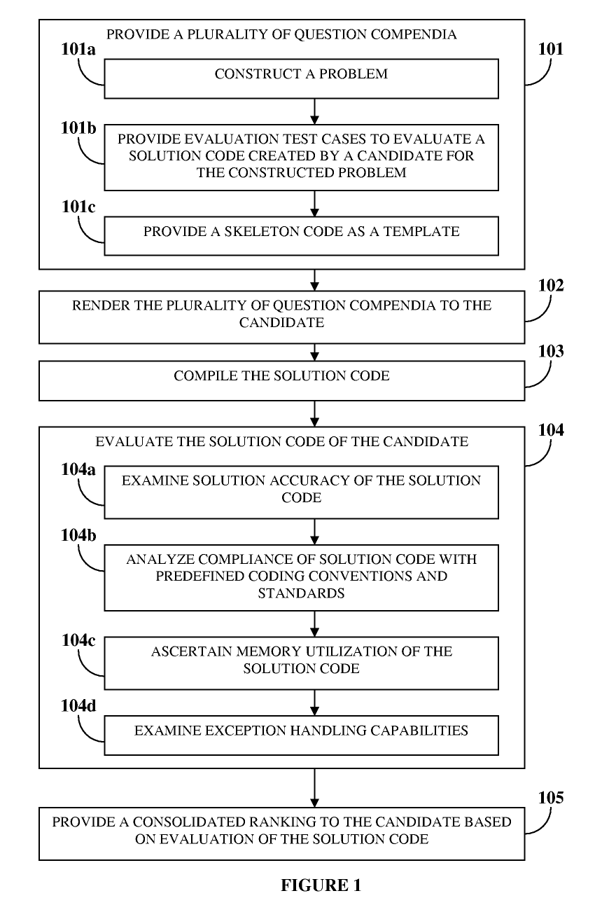

FIG. 1 illustrates a method of evaluating the software programming skills of a candidate. The candidate is provided with a plurality of question compendia 101. Each of the question compendia comprises a constructed problem 101a requiring a solution in the form of a program code, a set of evaluation test cases 101b, and a skeleton code 101c. The evaluation test cases are used to evaluate the solution code submitted by the candidate. The skeleton code serves as a template for creating the solution code. Depending on the candidate's programming skill level to be determined, question compendia are rendered 102 based on logical and technical levels of the candidate to be evaluated. Each of the question compendia is assigned a difficulty level based on logical and technical complexities of the constructed problem. The logical complexities refer to difficulties in comprehending and visualizing the constructed problem. The technical complexities refer to difficulties in implementing the solution code for the constructed problem. The question compendia are grouped based on the difficulty level. The question compendia may then be rendered to the candidate as a group or sequentially based on the logical and technical levels of the candidate to be evaluated. The question compendia may also be rendered adaptively based on the candidate's real time performance on the previously rendered question compendia. Based on the question compendia, the candidate creates a solution code for the constructed problem using the skeleton code provided as a code template. The solution code is then transferred to a virtual machine server 204 for compilation.

The virtual machine server 204 comprises a compiler 204b for compiling the solution code. The compiler 204b compiles 103 the solution code created by the candidate upon initiation of a compilation request. If one candidate submits the solution code for multiple compilations or multiple candidates submit their solution codes for compilation, multiple compilation requests are generated and listed for compiling the solution codes. The compiler 204b loads the common libraries and systems libraries required to compile each solution code. The loaded and parsed common libraries and system libraries are stored in a memory. The solution code created by the candidate is loaded to the compiler 204b and further parsed. The loaded solution code is linked with the stored common libraries and system libraries. The compiler 204b then creates a binary format of the solution code.

The solution code created by the candidate is then evaluated 104. The step of evaluating the solution code comprises examining 104a the solution code for solution accuracy to the constructed problem. Further, the solution code is analyzed 104b for code compliance with predefined coding conventions and standards. The evaluation of the solution code further comprises ascertaining 104c the memory utilization of the solution code. The solution code is also examined 104d for exception handling capabilities. The exception handling capabilities of the solution code include handling invalid inputs and error conditions affecting the flow of execution in the solution code. For example, the solution code should be able to handle exceptions such as reset, interrupt, signals from a memory management unit, or exceptions generated by an arithmetic logic unit or floating point unit for numerical errors such as invalid parameters values, divide b y zero, negative square root, overflow, etc.

Further, the solution code is evaluated by using evaluation test cases as inputs while executing the binary format of the solution code. The evaluation test cases determine whether the solution code offers the desired solution for the constructed problem. The accuracy of the solution code is tested by matching the output of each of the evaluation test cases with a predetermined expected output. The evaluation test cases then determine the solution code's error and exception handling capabilities during the solution code's execution.

The memory optimization capabilities of the solution code are examined based on memory usage of the solution code. The memory utilization during the execution of solution code is determined. The memory size of the solution code may also be determined. The combined utilization of the system memory and memory size of the solution code is used to determine the memory optimization capability of the solution code.

Scores are allotted to the candidate based on the correctness of the solution code. A test score is allotted to the candidate for obtaining a desired output of the solution code for each of the evaluation test cases. The allotted test score for each of the evaluation test cases is accumulated to rate correctness of the solution code. The deviation of the parsed solution code from the predefined coding conventions and standards are recorded and a deviation score is also allotted to the candidate based on the number of deviations. The number of compilations of the solution code in arriving at the correct solution code is recorded and a compilation score is allotted for the number of compilations of the solution code. Scores may also be allotted for the memory optimization capabilities of the solution code and the exception handling capabilities of the solution code. An accumulated score is calculated from the each of the allotted scores and a consolidated ranking is provided 105 to the candidate.

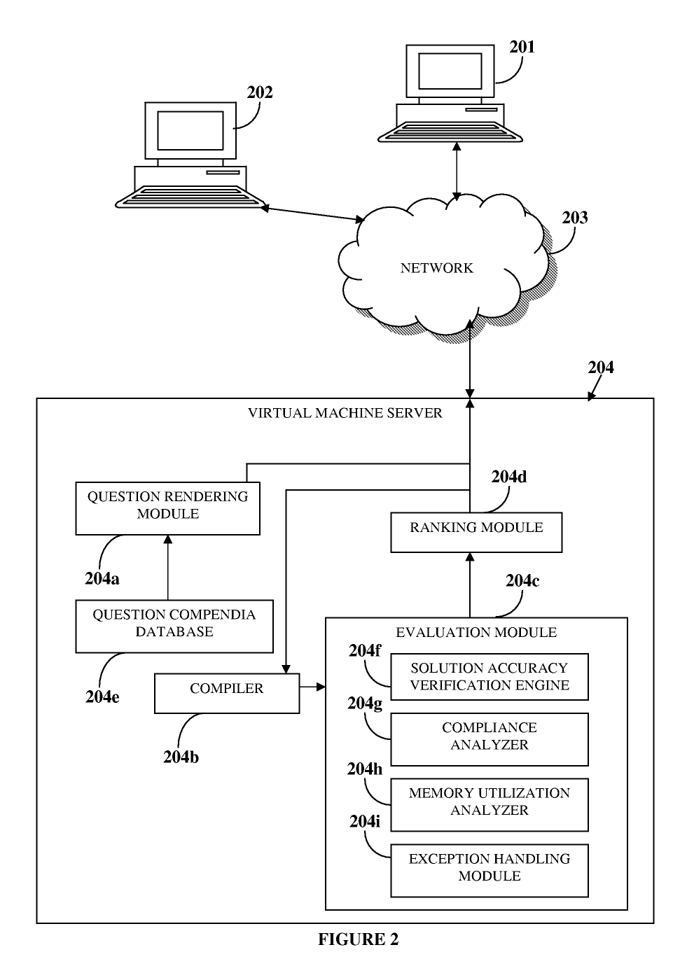

FIG. 2 illustrates a system for evaluating the software programming skills of a candidate. The system disclosed herein comprises a virtual machine (VM) server 204 connected to a network 203. The VM server 204 comprises a question rendering module 204a, a compiler 204b, an evaluation module 204c, and a ranking module 204d. The VM server 204 further comprises a question compendia database 204e. The question compendia database 204e stores a plurality of question compendia comprising the description of a problem, a set of evaluation test cases, and a skeleton code. The question rendering module 204a renders the question compendia to the candidate based on the logical and technical levels of the candidate to be evaluated. The question compendia may then be rendered to the candidate as a group or sequentially based on the logical and technical levels of the candidate to be evaluated. The question rendering module 204a may also adaptively render the question compendia to the candidate based on the candidate's real time performance on the previously rendered question compendia. The skeleton code provided to the candidate serves as a template to create the solution codes for the constructed problem in the question compendia. The set of evaluation test cases are used as inputs during the execution of the solution code to determine error and exception handling capabilities of the solution code. The solution code created by the candidate is transmitted over a network 203 to the VM server 204.

The compiler 204b is used to compile the solution code as explained in the detailed description of FIG. 1. The compiler 204b handles multiple compilation requests in parallel. The evaluation module 204c then evaluates the solution code of the candidate. The evaluation module 204c comprises, a solution accuracy verification engine 204f, a compliance analyzer 204g, a memory utilization analyzer 204h and an exception handling module 204i. The solution accuracy verification engine 204f examines the solution code for solution accuracy to the constructed problem. The solution accuracy verification engine 204f verifies the correctness of the solution code by evaluating the solution code using evaluation test cases as inputs while executing the binary format of the solution code. The evaluation test cases determine whether the solution code offers the desired solution for a problem. The accuracy of the solution code is tested by matching the output of each of the evaluation test cases with a predetermined expected output. The solution accuracy verification engine 204f allots scores to the candidate based on the correctness of the solution code. The solution accuracy verification engine 204f allots a test score for obtaining a desired output of the solution code for each of the evaluation test cases.

The compliance analyzer 204g analyzes the solution code for code compliance with predefined coding conventions and standards. The compliance analyzer 204g records the deviation of the solution code from the predefined coding conventions and standards and allots a deviation score to the candidate based on the number of deviations.

The memory utilization analyzer 204h ascertains the memory utilization of the solution code. The memory utilization analyzer 204h determines the system memory utilization during the execution of solution code. The memory size of the solution code is then determined by the memory utilization analyzer 204h. The combined utilization of the system memory and memory size of the solution code is used to determine the total memory utilization of the solution code. The memory utilization analyzer 204h may also perform a break-up analysis of the solution code to evaluate the memory utilization of individual components of the solution code. The exception handling capabilities of the solution code is tested using the exception handling module 204i.

The evaluation module 204c further allots a compilation score for the number of compilations of the solution code. Scores may also be allotted for the memory optimization capabilities of the solution code and the exception handling capabilities of the solution code by the evaluation module 204c. The evaluation module 204c then calculates an accumulated score from each of the allotted scores. The ranking module 204d then generates a consolidated ranking for the candidate based on the evaluation of the solution code. The ranking module 204d generates the consolidated ranking from the scores allotted to the candidate during the evaluation of the solution code.

Consider an example of the method and system disclosed herein. A first candidate working on a first computer 201 is provided with a question compendium by the question rendering module 204a for sorting 10,000 integers. A skeleton code is provided to the first candidate as a part of the question compendium. A set of evaluation test cases is used to evaluate the solution code of the first candidate. The evaluation test cases may be a list of 10,000 integers, a list of 20,000 integers, an array of characters, etc. If the list of 10,000 integers is provided as input to the solution code created by the first candidate, the expected output will be the sorted 10,000 integers. The array of characters is provided as input to assess the exception handling capabilities of the solution code. On providing the array of characters as the input to the solution code, an error message or a warning message should be expected from the solution code. The solution code is evaluated based on the correctness of solution, i.e. the sorted list of 10,000 integers, exception and error handling capabilities of the solution code for the input list of 20,000 integers and input array of characters, respectively. If the solution code fails to pass each of the evaluation tests, the first candidate is provided a lower score resulting in a lower ranking of the candidate.

Similarly the question rendering module 204a renders a question compendium to a second candidate working on a second computer 202 and a solution code created by second candidate is evaluated by the evaluation module 204c. A consolidated ranking is provided by the ranking module 204d to each of the candidates. In one implementation of the system disclosed herein, the candidates' systems 201 and 202 may be directly connected to the VM server 204 through the network 203.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product, comprising computer executable instructions embodied in a computer-readable medium, comprises computer parsable codes for the implementation of the processes of various embodiments.

Where databases are described, such as the question compendia database 204e, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of evaluating software programming skills of a candidate, comprising the steps of:
providing a plurality of question compendia, comprising the steps of:
constructing a problem;
providing a plurality of evaluation test cases to evaluate a solution code created by said candidate for said constructed problem;
providing a skeleton code as a template for creating said solution code;
rendering said plurality of question compendia to the candidate based on logical and technical levels of the candidate to be evaluated;
compiling the solution code;
evaluating the solution code of the candidate, comprising the steps of:
examining the solution code for solution accuracy to said constructed problem;
analyzing the solution code for code compliance with predefined coding conventions and standards;
ascertaining memory utilization of the solution code;
examining the exception handling capabilities of the solution code; and
providing a consolidated ranking to the candidate based on said step of evaluating the solution code.

2. The computer implemented method of claim 1, wherein deviations of the solution code from said predefined coding conventions and standards are recorded, and a deviation score is allotted to the candidate based on number of said deviations.

3. The computer implemented method of claim 1, wherein a test score is allotted to the candidate for obtaining a desired output of the solution code for each of said evaluation test cases.

4. The computer implemented method of claim 3, wherein said allotted test score for each of the evaluation test cases is accumulated to rate correctness of the solution code.

5. The computer implemented method of claim 1, wherein the step of evaluating the solution code is based on number of compilations performed on the solution code.

6. The computer implemented method of claim 5, wherein a compilation score is allotted to the candidate based on said number of compilations of the solution code.

7. The computer implemented method of claim 1, wherein each of the plurality of question compendia is assigned a difficulty level based on logical and technical complexities of the constructed problem.

8. The computer implemented method of claim 7, wherein said logical complexities refer to difficulties in comprehending and visualizing the constructed problem.

9. The computer implemented method of claim 7, wherein said technical complexities refer to difficulties in implementing the solution code for the constructed problem.

10. The computer implemented method of claim 7, wherein the plurality of question compendia is grouped based on said difficulty level.

11. A computer implemented system for evaluating software programming skills of a candidate, comprising:
a question rendering module for rendering a plurality of question compendia based on logical and technical levels of said candidate to be evaluated;
a compiler for compiling a solution code created by the candidate;
an evaluation module for evaluating said solution code, comprising:
a solution accuracy verification engine for examining the solution code for solution accuracy to a constructed problem;
a compliance analyzer for analyzing the solution code for code compliance with predefined coding conventions and standards;
a memory utilization analyzer for ascertaining memory utilization of the solution code;
an exception handling module for examining the exception handling capabilities of the solution code; and
a ranking module for generating a consolidated ranking for the candidate based on said evaluation of the solution code, wherein said consolidated ranking is generated from scores allotted to the candidate during said evaluation of the solution code.

12. The computer implemented system of claim 11, wherein said compiler handles multiple compilation requests in parallel.

13. A computer program product comprising computer executable instructions embodied in a computer-readable medium, wherein said computer program product comprises:
a first computer parsable program code for rendering a plurality of question compendia based on evaluation of logical and technical levels of a candidate to be evaluated.
a second computer parsable program code for compiling a solution code created by said candidate;
a third computer parsable program code for evaluating the solution code of the candidate, further comprising:
a fourth computer parsable program code for examining the solution accuracy of the solution code;
a fifth computer parsable program code for analyzing the solution code for code compliance with predefined coding conventions and standards;
a sixth computer parsable program code for ascertaining memory utilization of the solution code;
a seventh computer parsable program code for examining the exception handling capabilities of the solution code; and
an eighth computer parsable program code for providing a consolidated ranking to the candidate based on said step of evaluating the solution code, wherein said consolidated ranking is generated from scores allotted to the candidate during the evaluation of the solution code.
